(19) United States
(12) Patent Application Publication
(10) Pub. No.: US 2026/0351464 A1
(43) Pub. Date: Nov. 5, 2026

(54) ENHANCED STRUCTURE PRECISION COUPLER

(71) Applicant: MACOM Technology Solutions Holdings, Inc., Lowell, MA (US)

(72) Inventors: Vivek Anand, Carrigaline (IE); Michael Paul O'Connor, Innishannon (IE)

(21) Appl. No.: 19/664,392

(22) Filed: Apr. 30, 2026

Related U.S. Application Data
(60) Provisional application No. 63/797,705, filed on Apr. 30, 2025.

(51) Int. Cl. H01F 27/28; H01F 27/24

(52) U.S. Cl. CPC H01F 27/2823; H01F 27/24

(57) ABSTRACT

Enhanced precision couplers and coupler assemblies are described. An example coupler includes a core, a wire wound a number of turns around a region of the core, and an adhesion interposer extending over and between the wire and the core. The adhesion interposer can include a first adhesion interposer extending over and between the wire and a first region of the core and a second adhesion interposer positioned between the wire and a second region of the core. The adhesion interposers can be formed using a silicone-based room temperature vulcanizing (RTV) material in some implementations. The adhesion interposers can be helpful to maintain the positions of the windings with respect to each other and the core, ensure the electrical performance of the coupler, and provide other benefits.

### CROSS-REFERENCE TO RELATED APPLICATIONS

This application claims the benefit of and priority to U.S. Provisional Application No. 63/797,705, filed Apr. 30, 2025, the entire contents of which is hereby incorporated herein by reference.

### BACKGROUND

An electrical coupler inductor, also referred to as a coupled inductor or coupler, is an electrical component including two or more windings wound on a common core. A coupler facilitates the transfer of energy between two electrically-isolated circuits by mutual inductance. Couplers can be used in a number of different circuit applications, such as in RF circuits for impedance matching, filtering, and directional coupling, in power converters for current ripple cancellation and noise reduction, and in other applications. Couplers can also be relied upon for impedance matching between circuits and for other purposes.

### SUMMARY

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures.

An example coupler includes a core, a wire wound a number of turns around a region of the core, and an adhesion interposer extending over and between the wire and the core. The adhesion interposer can be embodied as an RTV material, such as a silicone-based RTV material, extending over and between the wire and the core. The adhesion interposer can include a first adhesion interposer extending over and between the wire and a first region of the core and a second adhesion interposer extending over and between the wire and a second region of the core.

In other aspects, the core can include a binocular core with two wiring apertures. The wire includes a first number of turns through a first wiring aperture among the two wiring apertures and around a first region of the core. The wire also includes a second number of turns through a second wiring aperture among the two wiring apertures and around a second region of the core. The first number of turns can be different than the second number of turns in some implementations. The adhesion interposer can also include a first adhesion interposer extending over and between the wire and the first region of the core and a second adhesion interposer extending over between the wire and the second region of the core.

In other aspects, the first adhesion interposer includes a first number of adhesion interposers that extend over and between the wire and a first region of the core. The second adhesion interposer includes a second number of adhesion interposers that extend over and between the wire and a second region of the core. The first number of adhesion interposers is different than the second number of adhesion interposers. In other cases, the first adhesion interposer includes a single adhesion interposer that extends over and between the wire and the first region of the core, and the second adhesion interposer includes two spaced-apart adhesion interposers that extend over and between the wire and the second region of the core.

In other aspects, the core can include a binocular core with two wiring apertures, and the wire includes four wires. Two wires among the four wires comprise a first number of turns through a first wiring aperture among the two wiring apertures and around a first region of the core. Two other wires among the four wires comprise a second number of turns through a second wiring aperture among the two wiring apertures and around a second region of the core. The first number of turns is different than the second number of turns. The adhesion interposer includes a first adhesion interposer extending over and between the two wires and the first region of the core and a second adhesion interposer extending over and between the two other wires and the second region of the core.

In other aspects, the first adhesion interposer includes a first number of adhesion interposers that extend over and between the two wires and the first region of the core. The second adhesion interposer includes a second number of adhesion interposers that extend over and between the two other wires and the second region of the core. The first number of adhesion interposers is different than the second number of adhesion interposers. In other cases, the first adhesion interposer includes a single adhesion interposer that extends over and between the two wires and the first region of the core, and the second adhesion interposer includes two spaced-apart adhesion interposers that extend over and between the other two wires and the second region of the core.

Another example coupler includes a core, a wire wound a number of turns around a region of the core, a first adhesion interposer extending over and between the wire and a first region of the core, and a second adhesion interposer extending over and between the wire and a second region of the core. The adhesion interposer can be embodied as an RTV material, such as a silicone-based RTV material, extending over and between the wire and the core.

In other aspects, the core includes a binocular core with two wiring apertures in some implementations. The wire includes a first number of turns through a first wiring aperture among the two wiring apertures and around the first region of the core. The wire also includes a second number of turns through a second wiring aperture among the two wiring apertures and around the second region of the core. The first number of turns can be different than the second number of turns in some implementations. The first adhesion interposer extends over and between the wire and the first region of the core, and the second adhesion interposer extends over and between the wire and the second region of the core.

An example coupler assembly includes a carrier substrate, a core secured over a top surface of the carrier substrate, a wire wound a number of turns around a region of the core, and an adhesion interposer extending over and between the wire and the core. The adhesion interposer can be embodied as an RTV material, such as a silicone-based RTV material, extending over and between the wire and the core. The adhesion interposer includes a first adhesion interposer extending over and between the wire and a first region of the core and a second adhesion interposer positioned between the wire and a second region of the core in some implementations.

In other aspects, the core includes a binocular core with two wiring apertures in some implementations. The wire includes a first number of turns through a first wiring aperture among the two wiring apertures and around a first region of the core. The wire also includes a second number of turns through a second wiring aperture among the two wiring apertures and around a second region of the core. The first number of turns can be different than the second number of turns in some cases.

In other aspects, the adhesion interposer includes a first adhesion interposer extending over and between the wire and the first region of the core and a second adhesion interposer extending over between the wire and the second region of the core. In some cases, the first adhesion interposer includes a first number of adhesion interposers that extend over and between the wire and the first region of the core, and the second adhesion interposer includes a second number of adhesion interposers that extend over and between the wire and the second region of the core. The first number of adhesion interposers is different than the second number of adhesion interposers in some implementations.

### BRIEF DESCRIPTION OF THE DRAWINGS

Aspects of the present disclosure can be better understood with reference to the following drawings. It is noted that the elements in the drawings are not necessarily drawn to scale, with emphasis instead being placed upon illustrating the principles of the examples. In the drawings, like reference numerals designate like or corresponding, but not necessarily the same, elements throughout the several views.

FIG. 1 illustrates parts of an example coupler assembly according to various examples described herein.

FIG. 2A illustrates a right side of the coupler assembly shown in FIG. 1, assembled together, according to various examples described herein.

FIG. 2B illustrates a left side of the coupler assembly shown in FIG. 2A according to various examples described herein.

FIG. 2C illustrates a top of the coupler assembly shown in FIG. 2A according to various examples described herein.

FIG. 2D illustrates a first end side of the coupler assembly shown in FIG. 2A according to various examples described herein.

FIG. 2E illustrates a second end side of the coupler assembly shown in FIG. 2A according to various examples described herein.

FIG. 3 illustrates a process of assembling and testing a coupler and coupler assembly according to various examples described herein.

### DETAILED DESCRIPTION

A coupler is an electrical component including two or more windings wound on a common core. A coupler facilitates the transfer of energy between two electrically-isolated circuits by mutual inductance. Couplers can be used in a number of different circuit applications, such as in RF circuits for impedance matching, filtering, and directional coupling, in power converters for current ripple cancellation and noise reduction, and in other applications. Couplers can also be relied upon for impedance matching between circuits and for other purposes.

New couplers and coupler assemblies are described herein. Among other aspects, the couplers are designed to maintain the positional accuracy and stability of inter-wire, wire-core, wire/core-substrate, and other electrical and structural aspects, to provide consistent electrical performance over time. The windings of the couplers can be tuned in some cases to achieve certain electrical parameters before materials for adhesion interposers are applied to the couplers and coupler assemblies. Adhesion interposers of silicone-based room temperature vulcanizing (RTV) material, for example, can be applied at discrete positions between and among lengths of wires and outer surfaces of cores of the couplers. The adhesion interposers can help to mechanically fix the positions of the wires of windings among each other and with respect to surface regions of the cores. The materials of the adhesion interposers can be selected to have a relatively low coefficient of thermal expansion, minimal parasitic effects, and other properties to provide improved electrical performance of the couplers over time.

An example coupler includes a core, a wire wound a number of turns around a region of the core, and an adhesion interposer extending over and between the wire and the core. The adhesion interposer can include a first adhesion interposer extending over and between the wire and a first region of the core and a second adhesion interposer positioned between the wire and a second region of the core. The adhesion interposers can be formed using an RTV material in some implementations. The adhesion interposers can be helpful to maintain the positions of the windings with respect to each other and the core, ensure the electrical performance of the coupler, and provide other benefits.

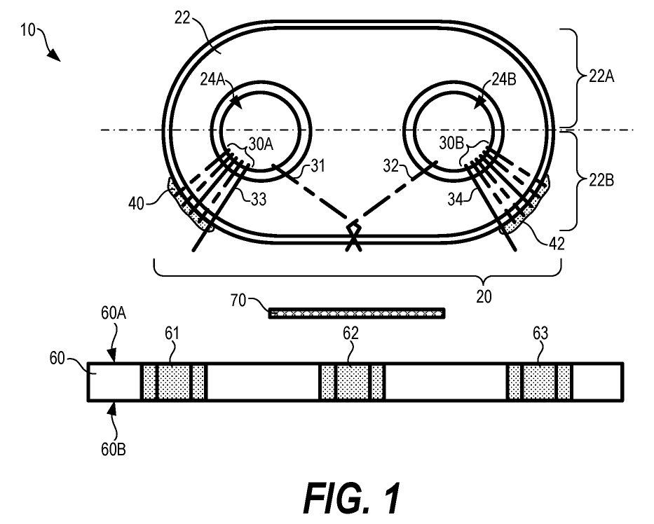

FIG. 1 illustrates parts of an example coupler assembly 10 according to various examples described herein. The coupler assembly 10 is depicted as a representative example in FIG. 1. The coupler assembly 10 is not drawn to any particular size or scale in FIG. 1. The coupler assembly 10 is also not exhaustively illustrated, and the coupler assembly 10 can include additional components that are not shown. The coupler assembly 10 can also omit certain components in some cases.

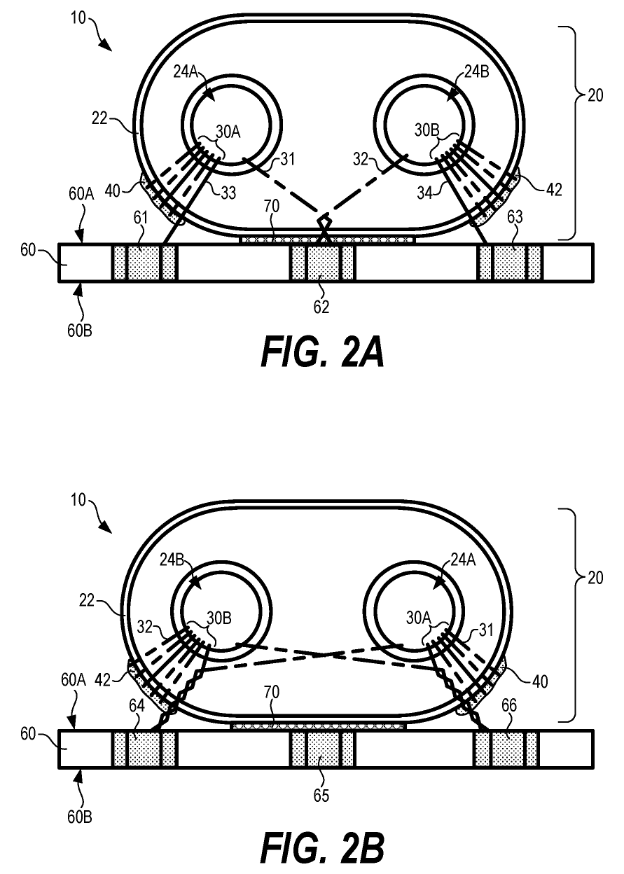

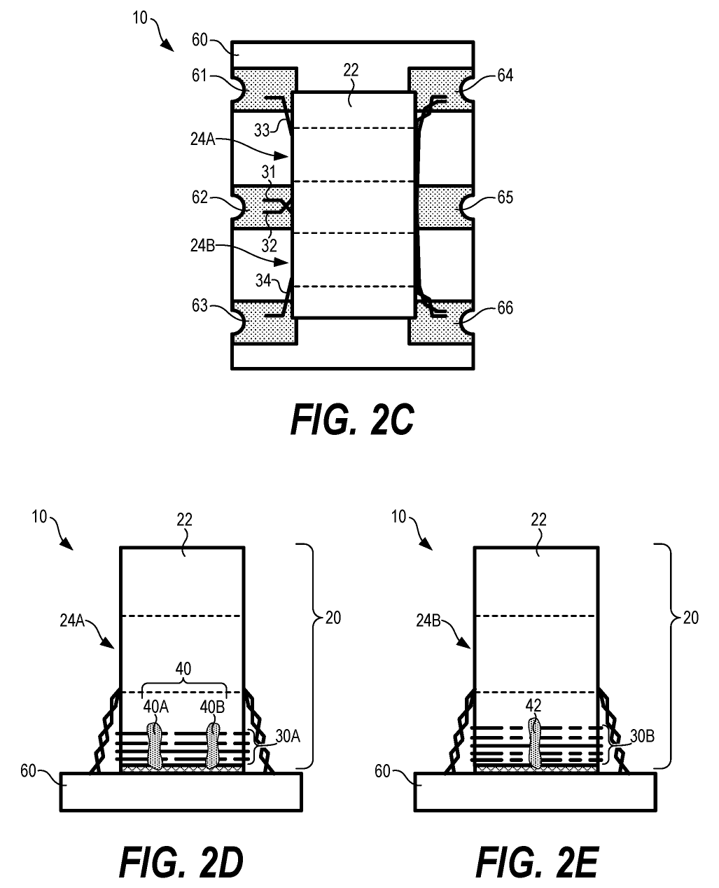

The coupler assembly 10 includes a coupler 20, a carrier substrate 60, and a core adhesive 70. The assembly of the coupler 20 with the carrier substrate 60 and the core adhesive 70 is described in further detail below with reference to FIGS. 2A-2E. The coupler 20 includes a core 22, one or more wires that are wound around the core 22, and adhesion interposers 40 and 42. In the example shown, four wires 31-34 are wound around the core 22 to form first windings 30A and second windings 30B (collectively “windings 30”) of the coupler 20. The adhesion interposer 40 is positioned and extends over and between a region of the first windings 30A and a first surface region of the core 22. The adhesion interposer 42 is positioned and extends over and between a region of the second windings 30B and a second surface region of the core 22.

The core 22 of the coupler 20 can be embodied as a ferrite or magnetic core with relatively high magnetic permeability and low electrical conductivity. The core 22 can be formed from a range of suitable materials, such as Manganese-Zinc (MnZn) ferrite, Nickel-Zinc (NiZn) ferrite, or other materials, and can have a range of magnetic permeabilities. The shape, style, and size of the core 22 can range among the embodiments, and other shapes, styles, and sizes can be relied upon. The core 22 is a binocular ferrite core in the example depicted in FIG. 1, and other shapes and styles of cores can be relied upon. The core 22 includes two wiring apertures or eyes in the example shown, including the apertures 24A and 24B. The core 22 also includes a top or upper half 22A and a bottom or lower half 22B, as designated in FIG. 1.

The windings 30 of the coupler 20 can be embodied as one or more magnet wires, such as enameled copper or aluminum wires coated with thin layers of insulation. The windings 30 can have any suitable gauge or diameter, such as between 20-50 American Wire Gauge (AWG), although other diameters can be relied upon. The windings 30 include four (4) separate and electrically separated wire strands in the example shown, including the first wire 31, the second wire 32, the third wire 33, and the fourth wire 34. The one or more wires that form the windings of the coupler 20 are also collectively referred to as a wire herein, for simplicity. In FIG. 1, the wires 31 and 32 are identified using a solid line, and the wires 33 and 34 are identified using a dashed line. The wires 31 and 32 can also be referred to as a first wire or winding herein, and the wires 33 and 34 can also be referred to as a second wire or winding herein. In some cases, the wires 31 and 32 can have a first color of insulating enamel, and the wires 33 and 34 can have a second color of insulating enamel different than the first color.

Each of the wires 31-34 includes two distal ends, which are electrically coupled to contact pads on the carrier substrate 60 as described below. Each of the wires 31-34 is the same AWG in preferred embodiments, but the AWG of one or more of the wires 31-34 can vary as compared to each other in some cases. As examples, each of the wires 31-34 can be embodied as a thirty (30), thirty-two (32), thirty-four (34), thirty-six (36), thirty-eight (38), or forty (40) AWG wire, and other AWG sizes can be relied upon.

The wires 31-34 are wound around the core 22 and, more particularly, through the apertures 24A and 24B of the core 22 to form the first windings 30A and the second windings 30B. The number of turns of each of the wires 31-34 through the apertures 24A and 24B can vary among the embodiments. In the example shown, the coupler 20 includes three (3) turns of the wire 31 through the aperture 24A and four (4) turns of the wire 32 through the aperture 24B. The coupler 20 also includes two (2) turns of the wire 33 through the aperture 24A and two (2) turns of the wire 34 through the aperture 24B. Thus, in the example depicted, the coupler 20 includes a fewer number of total turns of the wires 31 and 33 through the aperture 24A, and the coupler 20 includes a greater number of total turns of the wires 32 and 34 through the aperture 24B. Stated in a different way, a first number of wire turns of the first windings 30A through the aperture 24A is less than a second number of wire turns of the second windings 30B through the aperture 24B. The coupler 20 can include other numbers of turns of the wires 31-34 through the apertures 24A and 24B in other cases.

The adhesion interposers 40 and 42 can be embodied as a curable, insulating adhesive. In FIG. 1, the adhesion interposer 40 is shown extending over and between the wires 31 and 33 of the windings 30A and a first region of the core 22. More particularly, the adhesion interposer 40 is positioned and extends between and among lengths of the wires 31 and 33 and a first outer end surface of the core 22 in a first end region of the coupler 20, as also shown in FIG. 2D. The adhesion interposer 42 is shown extending over and between the wires 32 and 34 of the windings 30B and a second region of the core 22. More particularly, the adhesion interposer 42 is positioned and extends between and among lengths of the wires 32 and 34 and a second outer end surface of the core 22 in a second end region of the coupler 20, as also shown in FIG. 2E. In some cases, one or both of the adhesion interposers 40 and 42 can extend over and between the wires 31-34, the core 22, and the carrier substrate 60.

The adhesion interposers 40 and 42 can be embodied as a type of silicone rubber that cures at room temperature in a preferred embodiment. As a particular example, the adhesion interposers 40 and 42 can be embodied as the DOWSIL™ brand 3145 RTV MIL-A-46146 adhesive sealant of The Dow Chemical Company of Midland, Michigan, and other brands and types of RTV adhesive sealant can be relied upon. The use of RTV can be preferred to avoid unwanted electrical effects on the coupler 20 and the coupler assembly 10, such as unwanted parasitic capacitance, while also providing suitable mechanical robustness. The use of RTV can also be preferred for having a relatively low coefficient of thermal expansion (CTE), such that it does not significantly expand or contact after curing.

In other cases, the adhesion interposers 40 and 42 can be embodied as other types of insulating adhesives, glues, cements, or binders, including silicone adhesives, epoxies, polyurethanes, cyanoacrylates, hot melts, contact adhesives, and other types of adhesives. The positions and additional details of the adhesion interposers 40 and 42 are described below with reference to FIGS. 2D and 2E.

The carrier substrate 60 can be embodied as a range of suitable substrates. As one example, the carrier substrate 60 can be embodied as a printed circuit board (PCB) including layers of glass-reinforced epoxy laminate (e.g., FR4 or related laminate substrate material). The carrier substrate 60 is not limited to any particular type of material(s) however, and substrates including alumina, silicon, ceramic, polytetrafluoroethylene (PTFE), and other materials can be relied upon.

The carrier substrate 60 can include a number of contact pads. The carrier substrate 60 includes three (3) contact pads 61-63 positioned along a right-side edge of the carrier substrate 60 and three (3) contact pads 64-66 (see FIG. 2B) positioned along a left-side edge of the carrier substrate 60 in the example shown. The contact pad 62 is a central contact pad among the contact pads 61-63, and the contact pad 65 is a central contact pad among the contact pads 64-66. The carrier substrate 60 can include other numbers and positions of contact pads in other examples. Ends of the wires 31-34 are electrically coupled to the contact pads 64-66, as described in further detail below.

The contact pads 61-66 can be embodied as castellated edge contact pads. Each of the contact pads 61-66 includes electrically-conductive metal plating, extending from a top surface 60A of the carrier substrate 60, over the side edges of the carrier substrate 60, and to a bottom surface 60B of the carrier substrate 60. In other implementations, the carrier substrate 60 can include top-side contact pads on the top surface 60A which are electrically coupled to bottom-side contact pads on the bottom surface 60B by plated through-hole vias, and other arrangements can be relied upon.

The core adhesive 70 can be embodied as any suitable adhesive for mounting the core 22 of the coupler 20 to the carrier substrate 60. The core adhesive 70 is relied upon to secure the core 22 of the coupler 20 to the top surface 60A of the carrier substrate 60. The core adhesive 70 can be embodied as a type of epoxy adhesive. In a particular example, the core adhesive 70 can be embodied as the Chipbonder® 3621 Ultra High Speed Surface Mount Adhesive of Henkel AG & Co. KGaA of Düsseldorf, Germany, and other brands and types of mounting adhesive can be relied upon. In other cases, the core adhesive 70 can be embodied as other types of adhesives, glues, cements, adhesive pads, adhesive tapes, and other suitable means for securing the core 22 to the top surface 60A of the the carrier substrate 60.

FIG. 2A illustrates a right side of the coupler assembly 10 shown in FIG. 1, assembled together. FIG. 2B illustrates a left side of the coupler assembly 10. FIG. 2C illustrates a top of the coupler assembly 10. FIG. 2D illustrates a first end side of the coupler assembly 10, and FIG. 2D illustrates a second end side of the coupler assembly 10. Referring among FIGS. 2A and 2B, a bottom or lower surface of the core 22 of the coupler 20 is secured to the carrier substrate 60 using the core adhesive 70. The ends of the wires 31-34 are stripped and electrically coupled (e.g., soldered, sintered, welded, mechanically affixed, etc.) to the contact pads 61-66 on the top surface 60A of the carrier substrate 60.

In the example shown, one end of the wire 31 is electrically coupled to the contact pad 62, and another end of the wire 31 is electrically coupled to the contact pad 64. One end of the wire 32 is electrically coupled to the contact pad 62, and another end of the wire 32 is electrically coupled to the contact pad 66. One end of the wire 33 is electrically coupled to the contact pad 61, and another end of the wire 33 is electrically coupled to the contact pad 64. One end of the wire 34 is electrically coupled to the contact pad 63, and another end of the wire 32 is electrically coupled to the contact pad 66. Other electrical couplings between the wires 31-34, among possibly other wiring arrangements, and the contact pads 61-66, among possibly other contact pad arrangements, are within the scope of the embodiments.

The adhesion interposers 40 and 42 are also shown in FIGS. 2D and 2E. On a first end or side of the coupler 20 shown in FIG. 2D, the adhesion interposer 40 includes two (2) adhesion interposers 40A and 40B, which are separated and spaced-apart from each other. On a second end or side of the coupler 20 shown in FIG. 2E, the coupler 20 includes the one (1) adhesion interposer 42. Thus, the coupler 20 includes two (2) adhesion interposers 40A and 40B at a first end and one (1) adhesion interposer 42 at a second end opposite the first end. In other implementations, the coupler 20 can include only one adhesion interposer at both the first and second ends, two adhesion interposers at both the first and second ends, or other numbers of adhesion interposers at the first and second ends.

As shown in FIG. 2D, the adhesion interposer 40A is positioned between and among a first length or region of the first windings 30A and a first outer end surface region of the core 22. The adhesion interposer 40A coats and wraps around the first length or region of the first windings 30A and contacts the first outer end surface region of the core 22, to help secure the first windings 30A in place with respect to the core 22. The adhesion interposer 40A can be applied to extend both above and below the first windings 30A and across an outer surface of the core 22. The adhesion interposer 40B is positioned between and among a second length or region of the first windings 30A and a second outer end surface region of the core 22. The adhesion interposer 40B coats and wraps around the second length or region of the first windings 30A and contacts the second outer end surface region of the core 22, to help secure the first windings 30A in place with respect to the core 22. The adhesion interposer 40B can be applied to extend both above and below the first windings 30A and across an outer surface of the core 22.

As shown in FIG. 2E, the adhesion interposer 42 is positioned between and among a first length or region of the second windings 30B and a third outer end surface region of the core 22. The adhesion interposer 42 coats and wraps around the first length or region of the second windings 30B and contacts the third outer end surface region of the core 22, to help secure the second windings 30A in place with respect to the core 22. The adhesion interposer 42 can be applied to extend both above and below the second windings 30B and across an outer surface of the core 22. The coupler 20 includes two (2) adhesion interposers 40A and 40B at the first end of the coupler 20 with a fewer number of the first windings 30A and one (1) adhesion interposer 42 at the second end of the coupler 20 with a greater number of the second windings 30B.

The adhesion interposers 40A, 40B, and 42 are relied upon to mechanically fix and secure the windings 30 in position with respect to the core 22 of the coupler 20 and maintain the electrical performance of the coupler 20, even if the coupler 20 is subjected to mechanical vibration, temperature variation, and other changes in environmental conditions. The material of the adhesion interposers 40A, 40B, and 42 can be applied between the windings 30 and the core 22 through a nozzle, for example, and other methods of application can be relied upon. Once applied, the material of the adhesion interposers 40A, 40B, and 42 can be permitted to cure in a room temperature environment for a suitable length of time to set.

In some cases, one or more of the adhesion interposers 40A, 40B, and 42 can extend over and between the wires 31-34, the core 22, and the top surface 60A of the carrier substrate 60. Extending the materials of the adhesion interposers 40A, 40B, and 42 to the top surface 60A of the carrier substrate 60 can further help to mechanically fix and secure the windings 30 in position with respect to both the core 22 and the carrier substrate 60, even if the coupler 20 is subjected to mechanical vibration, temperature variation, and other changes in environmental conditions.

In some cases, the positions of the windings 30 can be moved or adjusted, as needed, before setting and securing the windings 30 in place with respect to each other and the core 22 using the adhesion interposers 40A, 40B, and 42. For example, the wires 31 and 33, and respective turns of the wires 31 and 33, can be positioned with respect to each other on and over the first end of the core 22, before the adhesion interposers 40A and 40B are applied and cured, to secure the wires 31 and 33 in that arrangement with respect to each other. Any two or more turns of the wires 31 and 33 can be placed closer together or further apart from each other, as compared to other turns of the wires 31 and 33, before the adhesion interposers 40A and 40B are applied and cured.

In a similar way, the wires 32 and 34, and respective turns of the wires 32 and 34, can be positioned with respect to each other on and over the second end of the core 22, before the adhesion interposer 42 is applied and cured, to secure the wires 32 and 34 in that arrangement with respect to each other. As an example, any two or more turns of the wires 32 and 34 can be placed closer together or further apart from each other, as compared to other turns of the wires 32 and 34, before the adhesion interposer 42 is applied and cured.

As noted above, the adhesion interposers 40A, 40B, and 42 can be particularly helpful to ensure the positions of the windings 30 with respect to each other and the core 22 during assembly of the coupler assembly 10 into a larger assembly, during solder reflow processes, and other steps that could cause movement of the windings 30. The adhesion interposers 40A, 40B, and 42 help to ensure the electrical performance of the coupler 20 and the coupler assembly 10, even after the coupler assembly 10 is installed into a larger circuit assembly. The adhesion interposers 40A, 40B, and 42 can ensure one or more electrical parameters of the coupler 20, such as a certain level of isolation, magnetic coupling, capacitance, inductance, impedance, impedance matching, or other parameters, are stable and consistent (e.g., within a certain tolerance range). The adhesion interposers 40A, 40B, and 42 can be relied upon to reduce variations in, or the tolerance of, one or more electrical parameters of the coupler 20, the coupler assembly 10, or both, even if subjected to mechanical vibration, temperature variation, and other changes in environmental conditions.

The positions of the adhesion interposers 40A, 40B, and 42 can vary as compared to that shown. For example, the adhesion interposers 40A and 40B can be closer together or further apart in some cases. The adhesion interposer 40 can also include three (3), four (4), or more adhesion interposers in some cases. The adhesion interposer 42 can be offset from center and located in other positions. The adhesion interposer 42 can also include two (2), three (3), four (4), or more adhesion interposers in some cases.

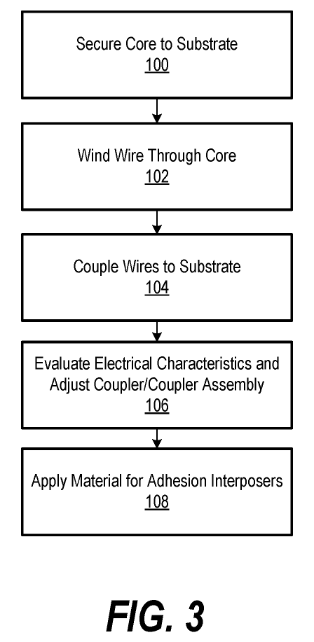

FIG. 3 illustrates a process of assembling and testing a coupler and coupler assembly. The process is described in connection with assembling and testing the coupler 20 and coupler assembly 10 shown in FIGS. 2A-2E, as an example, and other types of couplers and coupler assemblies can also be assembled and tested using the process. The process may include additional steps that are not shown or described. The process can also omit one or more of the steps shown and described in some cases, and the steps can be rearranged in a different order as compared to that shown and described in some cases. Before the process begins, the parts of the coupler and coupler assembly can be sourced or manufactured.

At reference numeral 100, the process includes securing a core to a substrate. For example, the method can include securing the core 22 to the top surface 60A of the carrier substrate 60. The core 22 can be placed on and over the top surface 60A of the carrier substrate 60, at about the center of the top surface 60A, with the core adhesive 70 positioned between the top surface 60A of the carrier substrate 60 and the bottom of the core 22. The core adhesive 70 can also be cured, as needed, to secure the core 22 on and over the top surface 60A of the carrier substrate 60.

At reference numeral 102, the process includes winding wire through and around the core to form the windings of the coupler and the coupler assembly. For example, the method can include winding the wires 31-34 through the apertures 24A and 24B of the core 22, to form the first windings 30A and the second windings 30B. In one implementation, the wires 31 and 33 are wound through the aperture 24A to form the first windings 30A, with a total of three turns of wire 31 and two turns of wire 33 through aperture 24A. Additionally, the wires 32 and 34 are wound through the aperture 24B to form the second windings 30B, with a total of four turns of wire 32 and two turns of wire 34 through the aperture 24B. All windings of the wires 31, 32, 33, and 34 are positioned over and wound around the bottom or lower half 22B of the core 22, as shown in FIG. 1, and the first and second windings 30A and 30B do not cover the top or upper half 22A of the core 22 in preferred embodiments. In other implementations, the winding at reference numeral 102 can include winding the wires 31, 32, 33, and 34, and/or other wires, through the apertures 24A and 24B for a different number of turns.

At reference numeral 104, the process includes coupling the wires to the substrate. For example, the process can include stripping the ends of the wires 31-34 and electrically coupling (e.g., soldering, sintering, welding, mechanically affixing, etc.) the stripped ends of the wires 31-34 to certain contact pads 61-66 of the carrier substrate 60. In one implementation, one end of the wire 31 is electrically coupled to the contact pad 62, and another end of the wire 31 is electrically coupled to the contact pad 64. One end of the wire 32 is electrically coupled to the contact pad 62, and another end of the wire 32 is electrically coupled to the contact pad 66. One end of the wire 33 is electrically coupled to the contact pad 61, and another end of the wire 33 is electrically coupled to the contact pad 64. One end of the wire 34 is electrically coupled to the contact pad 63, and another end of the wire 32 is electrically coupled to the contact pad 66. Other electrical couplings between the wires 31-34, among possibly other wiring arrangements, and the contact pads 61-66, among possibly other contact pad arrangements, can also be relied upon.

At reference numeral 106, the process includes evaluating the electrical characteristics of the coupler and the coupler assembly, as assembled based on the previous steps. For example, the electrical parameters of the coupler assembly 10 and particularly the coupler 20 can be tested using a network analyzer, such as a vector network analyzer or related network analyzer tool. The evaluated electrical parameters can including coupling, main line loss, return loss, isolation, S-parameters, and other characteristics of the coupler assembly 10 and the coupler 20 across a specified frequency band.

Based on the feedback provided by the network analyzer, the process can also include adjusting the coupler assembly 10 and/or the coupler 20 at reference numeral 106. For example, the first windings 30A, the second windings 30B, or both the first and second windings 30A and 30B can be adjusted (e.g., moved or repositioned) to tailor certain electrical characteristics of the coupler assembly 10 and the coupler 20. In some cases, the positions of one or both of the wires 31 and 33, or certain turns of the wires 31 and 33, can be adjusted or repositioned with respect to each other and the core 22. Any two or more turns of the wires 31 and 33 can be placed closer together or further apart from each other, as compared to other turns of the wires 31 and 33, to further tailor and improve the electrical characteristics of the coupler assembly 10 and the coupler 20. The positions of one or both of the wires 32 and 34, or certain turns of the wires 32 and 34, can also be adjusted or repositioned with respect to each other and the core 22. Any two or more turns of the wires 32 and 34 can be placed closer together or further apart from each other, as compared to other turns of the wires 32 and 34. Thus, the inter-winding gaps between individual turns of the wires 31-34 can be adjusted at reference numeral 106, as needed, to arrive at a coupler assembly 10 and coupler 20 having electrical characteristics within a target range.

At reference numeral 108, the process includes applying material to form one or more adhesion interposers extending over and between the wire and the core of the coupler of the coupler assembly. The process can include applying an RTV material, such as a silicon-based RTV material, over and between the wire and the core of the coupler, as described herein. As an example, the process can include applying an RTV material to form the adhesion interposers 40A and 40B on the first end or side of the coupler 20, as shown in FIG. 2D and described above. The process can also include applying an RTV material to form the adhesion interposer 42 on the second end or side of the coupler 20, as shown in FIG. 2E and described above. Other numbers, positions, and arrangements of adhesion interposers can also be formed at reference numeral 108, as described herein.

The RTV material of the adhesion interposers 40A, 40B, and 42 can be applied between the wires of the windings 30 and the core 22 through a nozzle, for example, and other methods of application can be relied upon. Other types of materials can be relied upon to form the adhesion interposers, such as insulating adhesives, glues, cements, or binders, including silicone adhesives, epoxies, polyurethanes, cyanoacrylates, hot melts, contact adhesives, and other types of adhesives. Once applied, the material of the adhesion interposers can be permitted to cure and set, after which the positions of the wires 31-34 of the windings 30 are mechanically fixed with respect to the core 22.

In additional process steps, the coupler assembly can be tested against final electrical specifications to confirm performance parameters. A number of the coupler assemblies can then be packaged for surface mount assembly techniques. For example, a number of coupler assemblies can be placed into respective pockets of a carrier tape and wound onto a reel. The coupler assemblies can be oriented within the carrier tape pockets in a consistent orientation, to facilitate automated pick-and-place assembly. The coupler assemblies can then be fed into a pick-and-place machine and placed onto PCB, along with other surface mount components, and subjected to solder reflow to electrically and mechanically couple contact pads of the carrier substrates to contact pads on the PCB.

In view of the limitations of the manufacturing and processing techniques available in the field, the terms “approximately” and “about” reflect a certain inability (or uncertainty) to precisely control the exact dimensions of certain features described herein. Depending on the level of precision that can be achieved using the commercially available semiconductor processing tools available at the time, the terms “approximately” and “about” may be used to mean within ±20% of a target value for some features, within ±10% of a target value for some features, within ±5% of a target value for some features, and within ±2% of a target value for some features. The terms “approximately” and “about” may include the target value.

The concepts described herein can be combined in one or more embodiments in any suitable manner, and the features discussed in the embodiments are interchangeable in some cases. Example embodiments are described herein, although a person of skill in the art will appreciate that the technical solutions and concepts can be practiced in some cases without all of the specific details of each example. Additionally, substitute or equivalent steps, components, materials, and the like may be employed. It should also be appreciated that some well-known process steps, semiconductor material layers, semiconductor device features, and other features have been omitted to avoid obscuring the concepts.

Although relative terms such as “on,” “below,” “upper,” “lower,” “top,” “bottom,” “right,” and “left” may be used to describe the relative spatial relationships of certain structural features, these terms are used for convenience only, as a direction in the examples. Thus, if a structure is turned upside down, the “upper” component will become a “lower” component. When a structure or feature is described as being “on” (or formed on) another structure or feature, the structure can c positioned directly on (i.e., contacting) the other structure, without any other structures or features intervening between the structure and the other structure. When a structure or feature is described as being “over” (or formed over) another structure or feature, the structure can be positioned over the other structure, with or without other structures or features intervening between them.

When two components are described as being “coupled to” each other, the components can be electrically coupled to each other, with or without other components being electrically coupled and intervening between them. When two components are described as being “directly coupled to” each other, the components can be electrically coupled to each other, without other components being electrically coupled between them.

Terms such as “a,” “an,” “the,” and “said” are used to indicate the presence of one or more elements and components. The terms “comprise,” “include,” “have,” “contain,” and their variants are used to be open ended and may include or encompass additional elements, components, etc., in addition to the listed elements, components, etc., unless otherwise specified. The terms “first,” “second,” etc. may be used as differentiating identifiers of individual or respective components among a group thereof, rather than as a descriptor of a number of the components, unless clearly indicated otherwise.

Although embodiments have been described herein in detail, the descriptions are by way of example. The features of the embodiments described herein are representative and, in alternative embodiments, certain features and elements can be added or omitted. Additionally, modifications to aspects of the embodiments described herein can be made by those skilled in the art without departing from the spirit and scope of the present invention defined in the following claims, the scope of which are to be accorded the broadest interpretation so as to encompass modifications and equivalent structures.

1. A coupler comprising:
a core;
a wire wound a number of turns around a region of the core; and
an adhesion interposer comprising a room temperature vulcanizing (RTV) material extending over and between the wire and the core.

2. The coupler of claim 1, wherein the adhesion interposer comprises a first adhesion interposer extending over and between the wire and a first region of the core and a second adhesion interposer extending over and between the wire and a second region of the core.

3. The coupler of claim 1, wherein:
the core comprises a binocular core with two wiring apertures;
the wire comprises a first number of turns through a first wiring aperture among the two wiring apertures and around a first region of the core and a second number of turns through a second wiring aperture among the two wiring apertures and around a second region of the core, the first number of turns being different than the second number of turns; and
the adhesion interposer comprises a first adhesion interposer extending over and between the wire and the first region of the core and a second adhesion interposer extending over between the wire and the second region of the core.

4. The coupler of claim 3, wherein:
the first adhesion interposer comprises a first number of adhesion interposers that extend over and between the wire and the first region of the core;
the second adhesion interposer comprises a second number of adhesion interposers that extend over and between the wire and the second region of the core; and
the first number of adhesion interposers is different than the second number of adhesion interposers.

5. The coupler of claim 3, wherein:
the first adhesion interposer comprises a single adhesion interposer that extends over and between the wire and the first region of the core; and
the second adhesion interposer comprises two spaced-apart adhesion interposers that extend over and between the wire and the second region of the core.

6. The coupler of claim 1, wherein:
the core comprises a binocular core with two wiring apertures;
the wire comprises four wires;
two wires among the four wires comprise a first number of turns through a first wiring aperture among the two wiring apertures and around a first region of the core;
two other wires among the four wires comprise a second number of turns through a second wiring aperture among the two wiring apertures and around a second region of the core, the first number of turns being different than the second number of turns; and
the adhesion interposer comprises a first adhesion interposer extending over and between the two wires and the first region of the core and a second adhesion interposer extending over and between the two other wires and the second region of the core.

7. The coupler of claim 6, wherein:
the first adhesion interposer comprises a first number of adhesion interposers that extend over and between the two wires and the first region of the core;
the second adhesion interposer comprises a second number of adhesion interposers that extend over and between the two other wires and the second region of the core; and
the first number of adhesion interposers is different than the second number of adhesion interposers.

8. The coupler of claim 6, wherein:
the first adhesion interposer comprises a single adhesion interposer that extends over and between the two wires and the first region of the core; and
the second adhesion interposer comprises two spaced-apart adhesion interposers that extend over and between the other two wires and the second region of the core.

9. A coupler comprising:
a core;
a wire wound a number of turns around a region of the core;
a first adhesion interposer extending over and between the wire and a first region of the core; and
a second adhesion interposer extending over and between the wire and a second region of the core.

10. The coupler of claim 9, wherein:
the core comprises a binocular core with two wiring apertures;
the wire comprises a first number of turns through a first wiring aperture among the two wiring apertures and around the first region of the core and a second number of turns through a second wiring aperture among the two wiring apertures and around the second region of the core, the first number of turns being different than the second number of turns; and
the first adhesion interposer extends over and between the wire and the first region of the core and the second adhesion interposer extends over and between the wire and the second region of the core.

11. The coupler of claim 10, wherein:
the first adhesion interposer comprises a first number of adhesion interposers that extend over and between the wire and the first region of the core;
the second adhesion interposer comprises a second number of adhesion interposers that extend over and between the wire and the second region of the core; and
the first number of adhesion interposers is different than the second number of adhesion interposers.

12. The coupler of claim 10, wherein:
the first adhesion interposer comprises a single adhesion interposer that extends over and between the wire and the first region of the core; and
the second adhesion interposer comprises two spaced-apart adhesion interposers that extend over and between the wire and the second region of the core.

13. The coupler of claim 9, wherein:
the core comprises a binocular core with two wiring apertures;
the wire comprises four wires;
two wires among the four wires comprise a first number of turns through a first wiring aperture among the two wiring apertures and around a first region of the core;
two other wires among the four wires comprise a second number of turns through a second wiring aperture among the two wiring apertures and around a second region of the core, the first number of turns being different than the second number of turns; and
the adhesion interposer comprises a first adhesion interposer extending over and between the wire and the first region of the core and a second adhesion interposer extending over and between the two other wires and the second region of the core.

14. The coupler of claim 13, wherein:
the first adhesion interposer comprises a first number of adhesion interposers that extend over and between the two wires and the first region of the core;
the second adhesion interposer comprises a second number of adhesion interposers that extend over and between the two other wires and the second region of the core; and
the first number of adhesion interposers is different than the second number of adhesion interposers.

15. The coupler of claim 9, wherein:
the first adhesion interposer comprises a single adhesion interposer; and
the second adhesion interposer comprises two spaced-apart adhesion interposers.

16. A coupler assembly comprising:
a carrier substrate;
a core secured over a top surface of the carrier substrate;
a wire wound a number of turns around a region of the core; and
an adhesion interposer comprising a room temperature vulcanizing (RTV) material extending over and between the wire and the core.

17. The coupler assembly of claim 16, wherein the adhesion interposer comprises a first adhesion interposer extending over and between the wire and a first region of the core and a second adhesion interposer positioned between the wire and a second region of the core.

18. The coupler assembly of claim 16, wherein:
the core comprises a binocular core with two wiring apertures;
the wire comprises a first number of turns through a first wiring aperture among the two wiring apertures and around a first region of the core and a second number of turns through a second wiring aperture among the two wiring apertures and around a second region of the core, the first number of turns being different than the second number of turns; and
the adhesion interposer comprises a first adhesion interposer extending over and between the wire and the first region of the core and a second adhesion interposer extending over between the wire and the second region of the core.

19. The coupler assembly of claim 18, wherein:
the first adhesion interposer comprises a first number of adhesion interposers that extend over and between the wire and the first region of the core;
the second adhesion interposer comprises a second number of adhesion interposers that extend over and between the wire and the second region of the core; and
the first number of adhesion interposers is different than the second number of adhesion interposers.

20. The coupler assembly of claim 18, wherein:
the first adhesion interposer comprises a single adhesion interposer; and
the second adhesion interposer comprises two spaced-apart adhesion interposers.
